(19) United States
(12) Patent Application Publication
(10) Pub. No.: US 2014/0009369 A1
(43) Pub. Date: Jan. 9, 2014

(54) LCD Panel and LCD Device

(71) Applicants: Jinjie Wang, Shenzhen (CN); Cheng-hung Chen, Shenzhen (CN)

(72) Inventors: Jinjie Wang, Shenzhen (CN); Cheng-hung Chen, Shenzhen (CN)

(73) Assignee: SHENZHEN CHINA STAR OPTOELECTRONICS TECHNOLOGY CO. LTD., Shenzhen (CN)

(21) Appl. No.: 13/583,001

(22) PCT Filed: Jul. 9, 2012
(86) PCT No.: PCT/CN12/78361

§ 371 Date: Sep. 6, 2012

(30) Foreign Application Priority Data
Jul. 4, 2012 (CN) 201210229696.6

(51) Int. Cl. G09G 3/36

(52) U.S. Cl. 345/32

(57) ABSTRACT

The present invention provide an LCD panel comprising, comprising an array substrate; a color filter substrate disposed relatively to the array substrate; and a data driver IC and a scan driver IC for driving the LCD panel, wherein, the data driver IC and the scan driver IC are electrically connected through a wire on array disposed on the array substrate; wherein, an electric field shielding layer connected to the ground is further disposed between the wire on array and the color filter substrate. The present invention also provides an LCD device comprising an LCD panel. Accordingly, the present invention can avoid driver ICs malfunctioning due to the voltage change of the wire on array in order to improve display quality of the LCD panel.

### BACKGROUND OF THE INVENTION

1. Field of the Invention

The present invention relates to the field of display technology, and more particularly to an LCD panel and an LCD display device.

2. Description of Related Art

LCD panel includes a TFT (Thin Film Transistor) substrate and a CP (Color Filter) substrate, wherein, the TFT substrate includes multiple data lines and multiple scan lines, and the data lines connect to data diver IC (also known as source driver IC), and the scan line connect to scan driver IC (also known as gate driver IC). A wire on array is disposed on the TFT array and between the data driver IC and the scan driver IC to achieve signal transmission. The CF substrate usually provides with ITO (Indium-Tin Oxide) transparent conductive film having equal area as the CF substrate.

The above conventional structure results in forming capacitors between the ITO transparent conductive film of the CF substrate and the data lines of LCD panel. And it also forms a parasitic capacitor between the ITO transparent conductive film of the CF substrate and the WOA connected between the data driver IC and scan driver IC. Therefore, when the LCD panel is displaying, the data lines of the TFT substrate transmit signals at the same time such that the voltage of ITO transparent conductive film on the CF substrate is influenced by the transmitted signals of the data lines. And the voltage change of the ITO transparent conductive film on the CF substrate also makes the voltage of WOA change. Because the driver IC will be affected by the voltage of the WOA, the voltage change of the WOA easily make the driver IC malfunction and cause the

screen to display exceptionally.

### SUMMARY OF THE INVENTION

The main technical problem solved by the present invention is to provide a liquid crystal display (LCD) panel and liquid crystal display device to eliminate malfunction phenomenon of driver ICs caused by the voltage change of wire on array. Thereby, it improves the display quality of the liquid crystal display panel.

To solve the above technical problem, a technical solution provided by the present invention is: an LCD panel comprising: an array substrate; a color filter substrate disposed relatively to the array substrate; and a data driver IC and a scan, driver IC for driving the LCD panel, wherein, the data driver IC and the scan driver IC are electrically connected through a wire on array disposed on the array substrate; wherein, an electric field shielding layer connected to the ground is disposed above the wire on array and the array substrate, and an insulating layer is disposed between the wire on array and the electric field shielding layer, and at least one pin of the data driver IC electrically connects to one terminal of the electric field shielding layer, and the pin of the data driver IC connected to the electric field shielding layer is ground.

Wherein, the electric field shielding layer is an ITO conductive film or an IZO conductive film.

Wherein, the width of the insulating layer and the electric field shielding layer are greater than or equal to the width of the wire on array.

To solve the above technical problem, another technical solution provided by the present invention is; an LCD panel comprising; an array substrate; a color filter substrate disposed relatively to the array substrate; and a data driver IC and a scan driver IC for driving the LCD panel, wherein, the data driver IC and the scan driver IC are electrically connected through a wire on array disposed on the array substrate; wherein, an electric field shielding layer connected to the ground is further disposed between the wire on array and the color filter substrate.

Wherein, the electric field shielding layer is disposed on the color filter substrate and is correspondingly disposed above the wire on array, and an insulating layer is disposed between the wire on array and the electric field shielding layer.

Wherein, the electric field shielding layer is disposed on the array substrate and above the wire on array, and an insulating layer is disposed between the wire on array and the electric field shielding layer.

Wherein, at least one pin of the data driver IC electrically connects to one terminal of the electric field shielding layer, and the pin of the data driver IC connected to the electric field shielding layer is ground.

Wherein, the electric field shielding layer is an ITO conductive film or an IZO conductive film.

Wherein, the width of the insulating layer and the electric field shielding layer are greater than or equal to the width of the wire on array.

To solve the above technical problem, another technical solution provided by the present invention is: an LCD device comprising a backlight system and an LCD panel, wherein, the LCD panel comprises: an array substrate; a color filter substrate disposed relatively to the array substrate; and a data driver IC and a scan driver IC for driving the LCD panel, wherein, the data driver IC and the scan driver IC are electrically connected through a wire on array disposed on the array substrate; wherein, an electric field shielding layer connected to the ground is further disposed between the wire on array and the color filter substrate.

Wherein, the electric field shielding layer is disposed on the color filter substrate and is correspondingly disposed above the wire on array, and an insulating layer is disposed between the wire on array and the electric field shielding layer.

Wherein, the electric field shielding layer is disposed on the array substrate and above the wire on array, and an insulating layer is disposed between the wire on array and the electric field shielding layer.

Wherein, at least one pin of the data driver IC electrically connects to one terminal of the electric field shielding layer, and the pin of the data driver IC connected to the electric field shielding layer is ground.

Wherein, the electric field shielding layer is an ITO conductive film or an IZO conductive film.

Wherein, the width of the insulating layer and the electric field shielding layer are greater than or equal to the width of the wire on array.

The beneficial effects of the present invention is: comparing to the prior art, the present invention provides the electric field shielding layer connected to grounded between the wire on array and the color filter substrate so that the voltage of the electric field shielding layer maintain constant. Therefore, it eliminates the influence to the wire on array 105 generated from the voltage change of the conductive film 121, and avoid the voltage of the wire on array generating change in order to avoid the driver IC malfunctioning so as to improve display quality of the LCD panel.

### BRIEF DESCRIPTION OF THE DRAWINGS

FIG. 1 is a partial structural schematic drawing of the first embodiment of the LCD panel of the present invention;

FIG. 2 is a sectional view of the LCD panel shown in FIG. 1;

FIG. 3 is a schematic drawing of the distribution of the capacitors of the LCD panel shown in FIG. 1;

FIG. 4 is a partial structural schematic drawing of the second embodiment of the LCD panel of the present invention;

FIG. 5 is a structural schematic drawing of an LCD device of the present invention.

### DETAILED DESCRIPTION OF THE PREFERRED EMBODIMENT

The following content combines figures and embodiments for detailed description of the present invention.

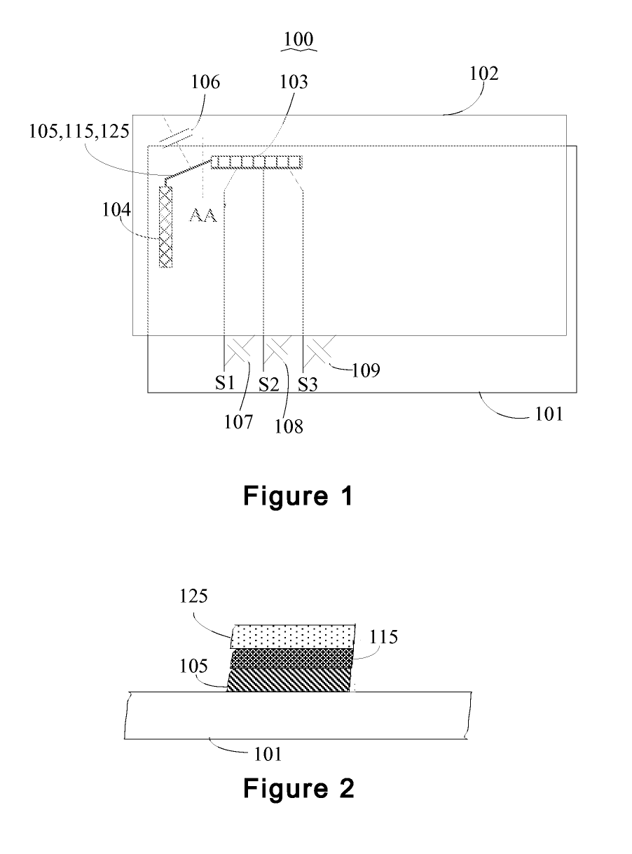

With reference to FIG. 1, FIG. 1 is a partial structural schematic drawing of the first embodiment of the LCD panel of the present invention. As shown in FIG. 1, An LCD display panel 100 of the invention comprises an array substrate 101, a color filter substrate 102, a data driver IC 103, and a scan driver IC 104.

Wherein, the array substrate 101 and the color filter substrate 102 are disposed relatively, and the data driver IC 103 and the scan driver IC 104 are used to driver the LCD panel 100. Wherein, the data driver IC 103 connects to multiple data lines, S1, S2, and S3, as shown in FIG. 1. The data driver IC 103 and the scan driver IC 104 are electrically connected by a wire on array 105 (WOA) disposed on the array substrate 101 so as to realize the signal transmission between the data driver IC 103 and the scan driver IC 104.

The data driver IC 103 transmit a control signal, a TFT on-state voltage Von, a TFT off-state voltage Voff, or other signals required by the scan driver IC 104 to the scan driver IC 104 through the wire on array 105 (WOA)

It should be understood that FIG. 1 only shows the wire on array 105 with one line as an example. In practical situation, the LCD panel 100 includes the wire on array 105 with multiple lines. For example, it at least includes one line of the wire on array used to transmit the control signal to the scan driver IC 104, another line of the wire on array used to transmit the TFT on-state voltage Von, and another line of the wire on array used to transmit the off-state voltage Voff.

In this embodiment, an electric field shielding layer 125 connected to ground is further disposed between the wire on array 105 and the color filter substrate 102, and an insulating layer 115 is disposed between the wire on array 105 and the electric field shielding layer 125,

Specifically, with reference to FIG. 2, FIG. 2 is a sectional view of the LCD panel shown in FIG. 1 along dotted line AA′.

With reference to FIG. 2, the wire on array 105 is disposed on the array substrate 101, and the electric field shielding layer 125 is disposed above the wire on array 105, and the insulating layer 115 is disposed between the wire on array 105 and the electric field shielding layer 125. Furthermore, the insulating layer 115 and the electric Held shielding layer 125 are disposed correspondingly above the extension direction of the wire on array 105, that is, the shape of the insulating layer 115 and the electric field shielding layer 125 are similar to the shape of the wire on array 105.

Wherein, the width of the insulating layer 115 and the electric field shielding layer 125 are greater than or equal to the width of the wire on array 105 so as to completely shield the wire on array 105 and achieve the ideal shielding effect.

In this embodiment, the electric field shielding layer 125 connects to the ground in order to maintain a zero voltage state. In this embodiment, it uses data driver IC 103 to provide the ground voltage for the electric field shielding layer 125, Specifically, at least one pin of the data driver IC 103 electrically connects to one terminal of the electric field shielding layer 125, and the pin of the data driver IC 103 connected to the electric field shielding layer 125 is ground. Accordingly, the data driver IC 103 transmits a around voltage to the electric field shielding layer 125 such that the electric field shielding layer 125 maintain the zero voltage state.

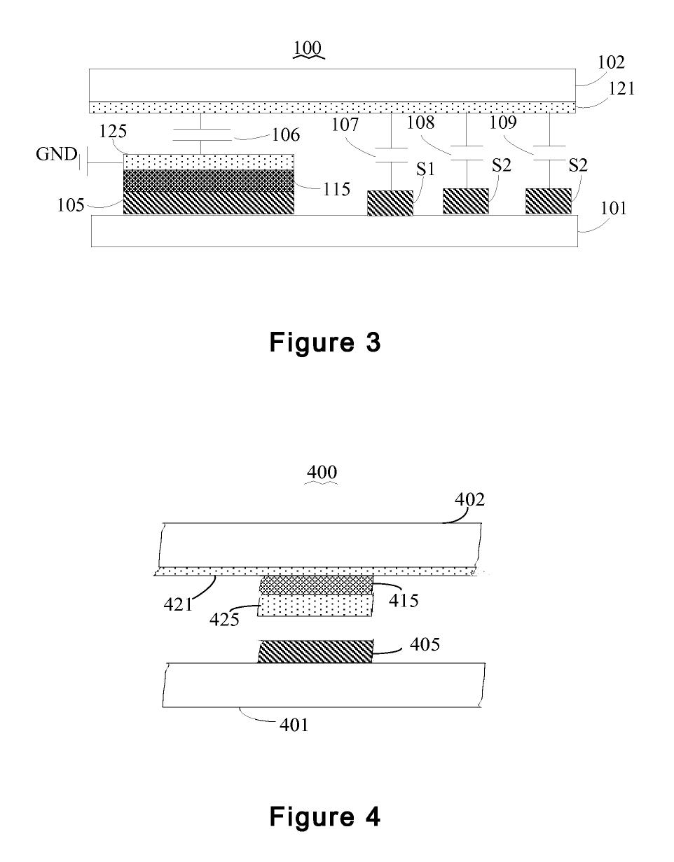

Please also refer to FIG. 3, FIG. 3 is a schematic drawing of the distribution of capacitors of the LCD panel shown in FIG. 1.

As shown in FIG. 3, a conductive film 121 with area equal to the color filter substrate 102 is disposed on the surface of the color filter substrate 102 relative to the array substrate 101.

In this embodiment, the conductive film 121 and the electric field shielding layer 125 are preferably ITO transparent conductive film or IZO (investigation of In-doped ZnO) transparent conductive film.

In the LCD panel 100, capacitors are formed between the data lines S1, S2, and S3 and the conductive film 121 of the color filter substrate 102, as the capacitors 107, 108, and 109 shown in FIG. 1 and FIG. 3. Similarly, a capacitor is also formed between the electric field shielding layer 125 and the conductive film 121, as a capacitor 106 shown in FIG. 1 and FIG. 3. Clearly, a capacitor between the conductive film 121 and the wire on array 105 become the capacitor 106 between the conductive film 121 and the electric field shielding layer 125. It is worth noting that there also exists a capacitor (not shown) between the wire on array 105 and the electric field shielding line 125, but capacitance of the capacitor (not shown) between the wire on array 105 and the electric field shielding line 125 is smaller, and does not change.

As described above, in present invention example, although the voltage of the conductive film 121 is easily influenced by the multiple data lines S1, S2 and S3 such that the voltage is changeable. However, the capacitor 106 between the electric field shielding layer 125 and the conductive film 121 isolates the wire on array 105 from being influenced by the changeable voltage of the conductive film 121. Meanwhile, the electric field shielding layer 125 maintain zero voltage state by connecting to the ground such that the changeable voltage of the conductive film 121 will not influence the voltage of the electric field shielding layer 125, The voltage of the electric field shielding layer 125 maintains constant in order to avoid the relative voltage change of the wire on array 105 by the influence of the voltage change of the conductive film 121. Therefore, it eliminates the influence to the wire on array 105 generated from the voltage change of the conductive film 121. Thereby, it avoids the driver IC, in particular the scan driver IC 104 to malfunction.

With reference to FIG. 4, FIG. 4 is a partial structural schematic drawing of the second embodiment of the LCD panel of the present invention. The sectional view along the dotted line AA′ shown in FIG. 1 is used as an example. The main difference between an LCD panel 400 of the embodiment and the LCD panel 100 shown in FIG. 1 is that an electric field shielding layer 425 of the LCD panel 400 is disposed on a color filter substrate 402 in this embodiment. Specifically, a wire on array 405 is disposed on the array substrate 401, and a transparent conductive layer 421 is disposed on the surface of the color filter substrate 402, and an electric field shielding layer 425 is disposed on the transparent conductive layer 421 and the upper location corresponding to the wire on array 405, and the insulating layer 415 is disposed between the transparent conductive layer 421 and the electric field shielding layer 425.

Furthermore, the insulating layer 415 and the electric field shielding layer 425 are disposed above the array line 405 and correspondingly along an extension direction of the array line 405, that is, the disposition shape of the insulating layer 415 and the electric field shielding layer 425 are similar to the wire on array 405. Wherein, the width of the insulating layer 415 and the electric field shielding layer 425 is greater than or equal to the width of the wire on array 405 to completely shield the wire on array 405 so as to achieve the ideal shielding effect.

Wherein, the working principle of the LCD panel 400 is the same with the LCD panel 100, not discussed again here.

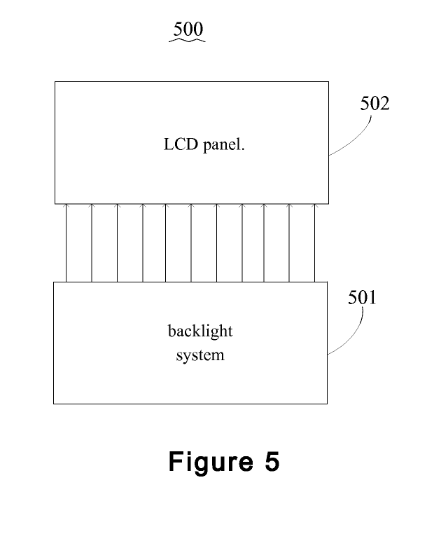

With reference to FIG. 5. FIG. 5 is a schematic drawing of an LCD device of the present invention. As shown in FIG. 5, an LCD device 500 of the present invention comprises a backlight system 501 and an LCD panel 502.

Wherein, the backlight system 501 provides light for the LCD panel 502, and the LCD panel 502 is the LCD panel shown in any embodiment in FIG. 1 to FIG. 4.

In summary, the present invention provides the electric field shielding layer connected to grounded between the wire on array and the color filter substrate so that the voltage of the electric field shielding layer maintain constant. Therefore, it eliminates the influence to the wire on array 105 generated from the voltage change of the conductive film 12 L and avoid the voltage of the wire on array generating change in order to avoid the driver IC malfunctioning so as to improve display quality of the LCD panel.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. An LCD panel comprising:
an array substrate;
a color filter substrate disposed relatively to the array substrate; and a data driver IC and a scan driver IC for driving the LCD panel wherein, the data driver IC and the scan driver IC are electrically connected through a. wire on array disposed on the array substrate;
wherein, an electric field shielding layer connected to the ground is disposed above the wire on array and the array substrate, and an insulating layer is disposed between the wire on array and the electric field shielding layer, and at least one pin of the data driver IC electrically connects to one terminal of the electric field shielding layer, and the pin of the data driver IC connected to the electric field shielding layer is ground.

2. The LCD panel according to claim 1, wherein, the electric field shielding layer is an ITO conductive film or an IZO conductive film.

3. The LCD panel according to claim 1, wherein, the width of the insulating layer and the electric field shielding layer are greater than or equal to the width of the wire on array.

4. An LCD panel comprising:
an array substrate:
a color filter substrate disposed relatively to the array substrate; and
a data driver IC and a scan driver IC for driving the LCD panel, wherein, the data driver IC and the scan driver IC are electrically connected through a wire on array disposed on the array substrate;
wherein, an electric field shielding layer connected to the ground is further disposed between the wire on array and the color filter substrate,

5. The LCD panel according to claim 4, wherein, the electric field shielding layer is disposed on the color filter substrate and is correspondingly disposed above the wire on array, and an insulating layer is disposed between the wire on array and the electric field shielding layer.

6. The LCD panel according to claim 4, wherein, the electric field shielding layer is disposed on the array substrate and above the wire on array, and an insulating layer is disposed between the wire on array and the electric field shielding layer.

7. The LCD panel according to claim 4, wherein, at least one pin of the data driver IC electrically connects to one terminal of the electric field shielding layer, and the pin of the data driver IC connected to the electric field shielding layer is ground.

8. The LCD panel according to claim 4. wherein, the electric field shielding layer is an ITO conductive film or an IZO conductive film.

9. The LCD panel according to claim 4, wherein, the width of the insulating layer and the electric field shielding layer are greater than or equal to the width of the wire on array.

10. An LCD device comprising a backlight system and an LCD panel, wherein, the LCD panel comprises:
an array substrate;
a color filter substrate disposed relatively to the array substrate; and
a data driver IC and a scan driver IC for driving the LCD panel, wherein, the data driver IC and the scan driver IC are electrically connected through a wire on array disposed on the array substrate;
wherein, an electric field shielding layer connected to the ground is further disposed between the wire on array and the color filter substrate.

11. The LCD device according to claim 10, wherein, the electric field shielding layer is disposed on the color filter substrate and is correspondingly disposed above the wire on array, and an insulating layer is disposed between the wire on array and the electric field shielding layer.

12. The LCD device according to claim 10, wherein, the electric field shielding layer is disposed on the array substrate and above the wire on array, and an insulating layer is disposed between the wire on array and the electric field shielding layer.

13. The LCD device according to claim 10, wherein, at least one pin of the data driver IC electrically connects to one terminal of the electric field shielding layer, and the pin of the data driver IC connected to the electric field shielding layer is ground.

14. The LCD device according to claim 10, wherein, the electric field shielding layer is an ITO conductive film or an IZO conductive film.

15. The LCD device according to claim 10, wherein, the width of the insulating layer and the electric field shielding layer are greater than or equal to the width of the wire on array.
